(19) United States
(12) Patent Application Publication
(10) Pub. No.: US 2019/0021310 A1
(43) Pub. Date: Jan. 24, 2019

(54) Using Peptides encapsulated in Rhamnolipid Liposomes for agriculture applications.

(71) Applicant: Keith DeSanto, St. Petersburg, FL (US)

(72) Inventor: Keith DeSanto, St. Petersburg, FL (US)

(21) Appl. No.: 15/899,494

(22) Filed: Feb. 20, 2018

Related U.S. Application Data
(60) Provisional application No. 62/517,264, filed on Jun. 9, 2017.
(60) Provisional application No. 62/521,616, filed on Jun. 19, 2017.

(51) Int. Cl. A01N 25/04; A01N 63/02

(52) U.S. Cl. CPC A01N 25/04; A01N 63/02

(57) ABSTRACT

Using Peptides encapsulated in Rhamnolipid Liposomes for agriculture applications. The chemically synthesized peptide ParE3, is an analogue from the ParE protein that acts on a Toxin-Antitoxin system. This application inhibits DNA Gyrase and Topoisomerase IV (Topo IV) activities, blocking the DNA bacterial replication and regulating its cell growth for new antimicrobial applications. Because Rhamnolipid has both hydrophilic and hydrophobic components, the Rhamnolipid Liposome combination facilitates the entry of the peptide into cell membranes. Cell permeability is created by using this application. When Using Peptides with Rhamnolipid Liposomes, microbial inhibition is obtained.

Rhamnolipids are one of the most important biosurfactant types (Haba et al., 2013) and are mainly produced by the fermentation rote of Pseudomonas aeruginosa, but they also can be produced by Rhodotorula taiwanensis, Lactobacillus Plantarum, Pseudomonas Rhizophila, Pseudomonas Chlororaphis and Burkholderia sp. They are recognized as a “green production” due to their low environmental cytotoxicity, but they also have high emulsification potential and antimicrobial activities. The two components of Rhamnolipid consist of a hydrophilic (water attracting) part and a hydrophobic (water hating) part. Because rhamnolipid is amphipathic (having both hydrophilic and hydrophobic parts), they can be used as liposomes. With this discovery, rhamnolipids with work better with liposomes for anti-bacterial and anti-fungal applications as opposed to not using liposomes.

### RHAMNOLIPIDS PRODUCTION

The production medium consisted of a Ca-free mineral salt solution with 15.0 g/L NaNO3, 0.5 g/L MgSO4×7 H2O, 1.0 g/L KCl and as a phosphate source 0.3 g/L K2HPO4. As sole carbon source soybean oil with a starting concentration of 250 g/L was used and 1 mL/L of the above-mentioned trace element solution was added.

The trace element solution contained 2.0 g/L sodium citrate×2 H2O, 0.28 g/L FeCl3×6 H2O, 1.4 g/L ZnSO4×7 H2O, 1.2 g/L CoCl2×6 H2O, 1.2 g/L CuSO4×5 H2O, and 0.8 g/L MnSO4×H2O.

The fermentation was carried out at 37° C., pH 6.9, and the process was carried out for 158 h.

The rhamnolipid produced was purified by acidification and then an extraction was carried out using ethyl acetate.

The molecular weight of the rhamnolipid is between 475 g/mol and 677 g/mol.

### Rhamnolipid Liposome Production

Vesicles were prepared in a PBS solution (pH 7.2-7.4) with a final combination of rhamnolipid, cholesterol and phosphatidylcholine concentration determined by Table 1. Firstly, each lipid were solubilized in chloroform, the solvent was evaporated by N₂, and in a vacuum bomb for 18 hours, to eliminate any chloroform residues. Then, the obtained films were hydrated with PBS solution (pH 7.2-7.4), the samples were vortexed and sonicated for 6 minutes by 21% of amplitude or extruded 30 times in a 0.1 μm membrane.

TABLE 1
Composition of the vesicles

| | Rhamnolipid | Cholesterol | PC* |
|---|---|---|---|
| Formulation | (mmol · L⁻¹) | (mmol · L⁻¹) | (mmol · L⁻¹) |
| A | 2.6 | — | — |
| B | 2.6 | — | 0.3 |
| C | 2.6 | 0.1 | — |
| D | 2.6 | 0.1 | 0.3 |

PC* phosphatidylcholine

### Synthesis, Purification and Identification of Peptides

LCParE3 was synthesized by Solid Phase Fmoc strategy, using a Rink-Amide MBHA resin and activated by DIC and HOBt. Then, it was acetylated with anidride acetic. The cleavage was done with TFA/water/EDTA/thioanisole (94:2.5:2.5:1) and ether. After it, LCParE3 was purified by HPLC (reverse phase) using a C18 column. Finally, the peptide was identified by mass spectrometry (ESI-MS Ion trap). To all experiments we used 100 μM of LCParE3.

### Physical and Chemical Measures of Liposomes

Dynamic light scattering (DLS) was used to measure the particle size and polydispersity of liposomes composed by formulations A, B, C and D. The DLS (Zetasizer-Malwern) was used at 173°, at controlled temperature (25±1° C.). Electrophoretic mobility of liposomes was measured by Zeta Potential, using the dynamic light scattering (Zetasizer-Malvern).

The morphology and organization of liposomes were evaluated by TEM. For this study, samples were placed on a cooper grid and observed by using the staining-negative technique, where a drop of 1% (w/v) aqueous solution of uranyl acetate was added. The samples were imaged under a transmission electron microscope (JEOL JEM-100CX2) with an acceleration of 100 kv. The diameter of the liposomes was then determined by ImageJ software.

### Efficiency of Encapsulation (EE %)

The efficiency of encapsulation (EE %) study was to evaluate by AMICON (50 kDa) centrifugation at 14.000×g during 14 minutes. Non-encapsulate peptide was able to cross the membrane and the solution was monitored by UV-Vis (280 nm). The concentration of peptide was done by a Lambert-Beer curve and efficiency of encapsulation was calculated by:

X=(Non-encapsulate Concentration Peptide×100)/(Initial Concentration of Peptide)

### Microbiological Assays:

To determine the growth cell inhibition of Escherichia coli 0157:H17 (ATCC 43895) and Staphylococcus aureus (ATCC 14458) by rhamnolipids liposomes entrapped with LCParE3 a National Committee for Clinical Laboratory Standards (CLSI, 2006) microdilution method was used.

### The Mechanism of Peptides Entering Cell Membranes

Because Rhamnolipid has both hydrophilic and hydrophobic components, the Rhamnolipid Liposome combination facilitates the entry of the peptide into cell membranes. Cell permeability is created by using this application. When Using Peptides with Rhamnolipid Liposomes, microbial inhibition is obtained.

1. Using a peptide encapsulated in a Rhamnolipid Liposome for plant and tree applications.

2. Using claim 1, where the chemically synthesized peptide is ParE3, an analogue from ParE protein that acts on a Toxin-Antitoxin system.

3. Using claim 1 to inhibit DNA Gyrase and Topoisomerase IV (Topo IV) activities, blocking the DNA bacterial replication and regulating its cell growth for new antimicrobial applications.

4. Using claims 2 and 3, where the peptide is blocked from entering the bacterial membrane, the Rhamnolipid Liposome combination facilitates the peptides entry into the cell membrane.

5. Using claim 4, the anti-microbial application creates cell membrane permeability.

6. Using claim 5, the application of microbial inhibition is obtained.

7. Using claim 6, Injecting into the stem or root of a plant or tree the peptide encapsulated in a Rhamnolipid Liposome to cure diseases affecting plants and trees.

8. Using claim 7 to prevent diseases in plants, bushes and trees.

9. Using claim 7 with the component of rhamnolipid being in powered form whereas the peptide encapsulated with the rhamnolipid liposomes is injected into the stem or root of a plant, bush or tree to cure disease.

10. Using claim 7 with the component of rhamnolipid being in aqueous form whereas the peptide encapsulated with the rhamnolipid liposomes where the rhamnolipid is injected into the stem or root of a plant, bush or tree to cure diseases.

11. Using claim 7, where a peptide encapsulated in a Rhamnolipid Liposome for agriculture applications is used to cure disease.

12. Using claim 4 whereas disease growth is impaired by its limited cell membrane permeability.

13. Using claims 2, 3, 4, 5, 6 and 12 to cure disease in humans and animals.

14. Using claims 2, 3, 4 5, 6 and 12 for anti-microbial applications.

15. Using claims 2, 3, 4 5, 6 and 12 for anti-bacterial applications.

16. Using a peptide encapsulated in a Biosurfactant Liposome for anti-microbial applications.

17. Using claim 16, the chemically synthesized peptide is ParE3, an analogue from ParE protein that acts on a Toxin-Antitoxin system.

18. Using claim 16 to inhibit DNA Gyrase and Topoisomerase IV (Topo IV) activities, blocking the DNA bacterial replication and regulating its cell growth for new antimicrobial applications.

19. Using claims 16 through 18 whereas the application creates cell membrane permeability.

20. Using claims 2 and 3 whereas a peptide encapsulated in a Rhamnolipid Liposome for household anti-microbial applications.
